(19) United States
(12) Patent Application Publication
(10) Pub. No.: US 2006/0236884 A1
(43) Pub. Date: Oct. 26, 2006

(54) Process for contact printing of patterns of electroless deposition catalyst

(75) Inventors: Luc Leenders, Herentals (BE); Michel Werts, Antwerpen (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Agfa-Gevaert, Mortsel (BE)

(21) Appl. No.: 11/112,013

(22) Filed: Apr. 20, 2005

(51) Int. Cl. B41F 33/00

(52) U.S. Cl. 101/483

(57) ABSTRACT

A process comprising the step of: contact printing a pattern of an electroless deposition catalyst via a hydrophilic phase to a receiving medium, wherein said electroless deposition catalyst requires no activation prior to electroless deposition.

### FIELD OF THE INVENTION

The present invention relates to a process for the contact printing of patterns of electroless deposition catalyst via a hydrophilic phase.

### BACKGROUND OF THE INVENTION

In addition to the printing of conventional colored inks, printing is being used more and more for the application of patterns of functional materials. In the case of functional materials which are only soluble or dispersible in aqueous media, problems may arise in incorporating them into oleophilic inks.

WO 01/88958 discloses in claim 1 a method of forming a pattern of a functional material on a substrate comprising: applying a first pattern of a first material to said substrate; and applying a second functional material to said substrate and said first material, wherein said first material, said second functional material, and said substrate interact to spontaneously form a second pattern of said second functional material on said substrate, to thereby form a pattern of a functional material on a substrate.

WO 01/88958 further discloses in claim 27 a method of forming a pattern of a functional material on a substrate comprising: non-contact printing a first pattern of a first material on said substrate; and applying a second functional material to said substrate and said first material, wherein said first material, said second material, and said substrate interact to spontaneously form a second pattern of said second functional material on said substrate, to thereby form a pattern of a functional material on a substrate.

WO 01/88958 also discloses in claim 47 a method of forming a pattern of a functional material on a substrate comprising: non-contact printing a first pattern of a first material on said substrate; and applying a second functional material to said substrate and said first material, wherein said first and second functional materials are selected to have a sufficient difference in at least one property of hydrophobicity and hydrophilicity relative to one another such that said first material, said second functional material, and said substrate interact to spontaneously form a second pattern of said second functional material on said substrate, to thereby form on said substrate a second pattern of said second functional material, wherein said second pattern is the inverse of said first pattern, to thereby form a pattern of a functional material on a substrate.

WO 01/88958 also discloses in claim 57 a method of forming an electrical circuit element, comprising: applying a first pattern of a first material on a substrate; and applying a second material to said substrate and said first material, wherein said first material, said second material, and said substrate interact to spontaneously form a second pattern of said second material on said substrate, thereby forming an electrical circuit element.

WO 01/88958 also discloses in claim 110 an electrical circuit element comprising: a substrate; a first pattern of an insulating material applied to said substrate; and a second pattern of an electrically conducting material applied to said substrate and said first material, wherein said insulating material, said electrically conducting material, and said substrate interact to spontaneously form a second pattern of said electrically conducting material on said substrate when said electrically conducting material is applied to said substrate having said first pattern of said insulating material applied thereon.

WO 01/88958 also discloses in claim 123 an electronic device comprising: a) a first element comprising i) a first substrate; ii) a first pattern of an insulating material applied to said substrate and iii) a second pattern of an electrically conducting material applied to said substrate and said first material, wherein said insulating material, electrically conducting material, and said substrate interact to spontaneously form a second pattern of said electrically conducting material on said substrate when said electrically conducting material is applied to said substrate having said first pattern of said insulating material applied thereon; b) a second circuit element comprising i) a second substrate; ii) a third pattern of an insulating material applied to said second substrate and iii) a fourth pattern of an electrically conducting material applied to said second substrate and said third material, wherein said insulating, electrically conducting material, and said second substrate interact to spontaneously form a fourth pattern of said electrically conducting material on said substrate when said electrically conducting material is applied to said substrate having said third pattern of said insulating material applied thereon; and c) an electrically connection between said first and second circuit elements.

WO 01/88958 also discloses in claim 127 a Radio Frequency (RF) tag comprising a pattern of a non-conductive first material on a substrate and a coating of an electrically conductive second material disposed over said substrate and said first material, wherein said first material, said second material, and said substrate interact to spontaneously form a second pattern of said second material on said substrate, to thereby form an Inductor-Capacitor (LC) resonator on said substrate.

WO 01/88958 also discloses in claim 141 a mechanical device comprising: a) a first component comprising: i) a first substrate; ii) a first pattern of first material to said first substrate and iii) a second pattern of material applied to said first substrate and said first material, wherein said second pattern of said second material is spontaneously formed by the interaction of said first material, said second material and said first substrate; and b) a second component comprising i) a second substrate; ii) a third pattern of a third material applied to said second substrate and iii) a fourth pattern of a fourth material applied to said second substrate and said third material, wherein said fourth pattern of said fourth material is spontaneously formed by the interaction of said third material, said fourth material and said substrate; and wherein said first and second components are oriented in a such a way that the second and fourth patterns oppose each other, and are selected from the group consisting of identical patterns, inverse patterns, and any mechanically useful combinations.

A number of different techniques can be used for printing. These techniques can be separated into so-called non-impact printing techniques, such as inkjet printing, electrographic printing, electrophoretic printing and electrophotographic printing using solid or liquid toners, and so-called contact printing techniques, such as screen printing, gravure printing, flexographic printing and offset printing. Depending on the application, substrate and desired print volume, different printing techniques will be better suited for the job. For the printing of high volumes at low cost, for example for the printing of packages, fast printing techniques are required such as gravure printing, flexographic printing or offset printing. The low cost is due to the high printing speeds of approximately 500 m/min or more for flexographic printing up to 900 m/min or more for heat set/web-offset printing. This makes offset printing particularly suitable for the cheap production of printed matter. Offset printing and gravure printing provide the highest quality prints with resolutions down to 10 μm.

In 2001, Hohnholz et al. in Synthetic Metals, volume 121, pages 1327-1328, reported a novel method for the preparation of patterns from conducting and non-conducting polymers on plastic/paper substrates. This method, “Line Patterning” (LP), does not involve printing of the polymers and incorporates mostly standard office equipment, e.g. an office type laser printer. It is rapid and inexpensive. The production of electronic components, e.g. a liquid crystal and a push-button assembly were reported.

Offset (lithographic) printing presses use a so-called printing master such as a printing plate which is mounted on a cylinder of the printing press. In conventional offset printing, the master carries a lithographic image on its surface, which consists of oleophilic (or hydrophobic, i.e. ink-accepting, water-repelling) areas as well as hydrophilic (or oleophobic, i.e. water-accepting, ink-repelling) areas. A print is obtained by first applying a fountain medium (also called dampening liquid) and then the ink to lithographic image on the surface of the printing plate on a drum, both are then transferred to an intermediate (rubber) roll, known as the offset blanket, from which they are further transferred onto the final substrate. The fountain medium is first transferred via a series of rolls to the printing plate. It conventionally acts as a weak sacrificial layer and prevents ink from depositing on the non-image area of the plate and has the function of rebuilding the non-printing (desensitized) areas of the printing plate during a press run. This is usually realized with an aqueous solution of acid, usually phosphoric acid, and gum arabic, the gum is adsorbed to the metal of the plate and thereby making a hydrophilic surface. The dampened plate then contacts an inking roller and only accepts the oleophilic ink in the oleophilic image areas. Fountain media have historically contained isopropyl alcohol to reduce the surface tension and thereby to provide for more uniform dampening of the printing plate, but, by eliminating (or greatly reducing) the isopropyl alcohol as a fountain medium additive, printers are able to reduce VOC (volatile organic compound) emissions significantly. In such fountain media isopropyl alcohol is replaced with lower volatility glycols, glycol ethers, or surfactant formulations. Conventional fountain media may also contain anti-corrosion agents, pH-regulators and surfactants.

EP-A 1 415 826 discloses a process for the offset printing of a receiving medium with a functional pattern comprising in any order the steps of: applying a printing ink to a printing plate and wetting said printing plate with an aqueous fountain medium containing a solution or a dispersion containing at least one moiety having at least colouring, pH-indicating, whitening, fluorescent, phosphorescent, X-ray phosphor or conductive properties.

In addition to conventional offset printing, several alternative methods have been developed, such as reverse lithography, driography and single fluid offset printing.

In reverse lithography, a water- or glycol-based hydrophilic colored ink is used in combination with an oleophilic fountain medium. The printing plate contains image areas which preferentially attract a hydrophilic liquid and non-image areas which are repellent to the hydrophilic liquids. Printing plates can be prepared by applying a pattern of a material with a good tolerance to aqueous (miscible) liquids such as a vinylacetate-ethylene copolymer resin, polyester resin or a composition containing shellac, polyethylene glycol and wax onto a hydrophobic base sheet, such as polystyrene or polyethylene coated Mylar. Alternatively, the printing plate can be prepared by applying a hydrophilic liquid-repelling thermosetting siloxane composition as the non-image pattern on a zinc base material (U.S. Pat. No. 3,356,030). Additives like carbon black or zinc oxide may be added to the resin to increase the surface roughness, thereby improving the ink uptake. The hydrophilic inks can be dye- or pigment-based and contain a binder and water and/or ethylene glycol as the main vehicle. The (hydrophobic) fountain medium is based on hydrocarbons such as Textile Spirits or Super Naphtolite, mineral oils or silicon oils.

Waterless or driographic offset printing was developed, for example by Toray Industries of Japan, to reduce the emission of VOCs from the fountain medium in conventional offset printing by dispensing with a fountain medium and only using an oleophilic ink. The non-image areas of a driographic printing plate are coated with an ink-repellant polymer, such as a silicone, while the image areas are ink-accepting surfaces for example a grained aluminium base plate, optionally overcoated with an additional coating layer. During driographic printing, only ink is supplied to the master.

However, these driographic printing processes still have the disadvantage of VOC emission from the oleophilic ink. This has resulted in the development of water-based driographic inks, which contain surfactants, rewetting agents, dyes and/or pigments and resins in addition to water. Such driographic printing plates can be used, with, for example, the grained aluminium surface of the printing plate as the image areas and any type of hydrophobic material that repels the ink for the non-image area.

Conventional and reverse offset printing require the continuous monitoring and adjusting of the ink/fountain balance so that the ink adheres exclusively to the printing areas of the plate to ensure the production of sharp, well-defined prints. Single-fluid inks have been developed to eliminate the need for the operator continuously to monitor and adjust the ink/fountain balance. These inks consist of a fine emulsion of the ink in the fountain or of a fine emulsion of the fountain in the ink and are applied to the printing plate via the ink rollers. The fountain is oleophilic when the ink is hydrophilic and is hydrophilic when the ink is oleophilic e.g. with the oleophilic ink part based on vinyl- and hydrocarbon resins with dyes and/or pigments and the hydrophilic fountain part based on glycol/water mixtures.

Reverse offset printing inks using a hydrocarbon or mineral oil as fountain medium are described in for example U.S. Pat. No. 3,532,532, U.S. Pat. No. 3,797,388, GB 1,343,784A and U.S. Pat. No. 3,356,030. None of these patents disclose the addition of functional materials, other than dyes and/or pigments, to the hydrophilic ink or to the hydrophobic fountain medium.

Water-based driographic offset inks are for example described in WO 99/27022A, WO 03/057789A and DE 4119348A. None of these patents discloses the addition to the hydrophilic ink of functional materials, other than dyes and/or pigments.

Single fluid inks for offset printing are, for example, disclosed in U.S. Pat. No. 4,981,517 and in WO 00/032705A, but neither discloses an ink containing functional materials in the hydrophilic (fountain) part of the ink emulsion.

US 2005/0003101A discloses a method of preparing a substrate such that it is capable of sponsoring autocatalytic plating of metal patterns over a pre-determined area of its surface comprising the steps of: i) coating some or all of the substrate material by a pattern transfer mechanism with a first layer composed of a first layer material comprising a catalytic material; ii) coating the first layer by a pattern transfer mechanism with a second layer composed of a second layer material such that the second layer overlaps the first layer to form a seal, the second layer material being incapable of promoting and/or sustaining the desired catalytic reaction iii) using an energetic ablative scribing process to remove a pre-determined pattern of material from the second layer material in order to expose the first layer material. The catalytic material is applied via a pattern transfer mechanism, such as inkjet printing or screen printing, coating a second layer over the first layer to form a seal and using an energetic ablative scribing process to remove a pre-determined pattern of the second layer in order to expose the first layer. Metal is deposited on the first catalytic layer by electroless plating. The disadvantage of this process is that the described scribing processes, such as e-beam, focused UV beam, collimated X-ray beam or plasma beams are slow processes.

DE 2757029A discloses a process for the manufacture of integrated circuits in which an ink enriched with palladium, copper or silver nuclei is printed on a substrate provided with an adhesion-providing layer, the conductive patterns thereby produced then being metallized chemically in a copper depositing bath to electrically conductive circuits. Neither the printing method nor the ink compositions are further specified.

WO 92/21790A discloses a method comprising printing a catalytic ink in a two-dimensional image on a moving web from a rotating gravure roll; wherein said catalytic ink comprises a solution of less than 10% by weight solids comprising polymer and a Group 1B or Group 8 metal compound, complex or colloid; wherein said ink has a viscosity between 20 and 600 centipoises as measured with a Brookfield No. 1 spindle at 100 rpm and 25° C.; and wherein said image is adaptable to electroless deposition of metal. This method has the disadvantage of the image not being directly usable for catalyzing electroless deposition. Moreover, rotogravure printing suffers from the disadvantages of the high cost of a gravure roll compared to an offset printing plate.

A stamp having a patterned surface, as described in U.S. Pat. No. 6,521,285, is an alternative method of applying a catalyst for electroless plating on a substrate from an aqueous solution. However, this method is not roll-to-roll and is very slow compared to offset printing.

Flexographic printing of a catalyst layer for the manufacturing of electromagnetic wave shield material is disclosed in JP patent 2002-223095A, but fails to disclose printing of a catalyst layer from a hydrophilic phase and suffers from the disadvantage of requiring relatively high viscosity inks, usually of the order of 200-600 mPa·s, for which binders are required. Other additives such as defoamers, waxes, surfactants, slip agents and plasticizers are often required to obtain the required printing properties.

U.S. Pat. No. 3,989,526 discloses a processing composition comprising a reducing agent and an inert transition metal complex oxidizing agent which undergo redox reaction in a liquid medium in the presence of catalytic material which is a zero valent metal or chalcogen of a Group VIII or 1B element, wherein said liquid is a solvent for said reducing agent and said inert transition metal ion complex, said inert transition metal complex comprising (a) Lewis bases and (b) Lewis acids which are capable of existing in at least two valence states and said oxidizing agent and said reducing agent being so chosen that (1) the reaction products thereof are noncatalytic for said oxidation-reduction reaction and (2) when test samples thereof are each dissolved in an inert solvent at a concentration of about 0.01 molar at 20° C., there is essentially no redox reaction between said oxidizing agent and said reducing agent, and said oxidizing agent being a complex of a metal ion with a liquid which, when a test sample thereof is dissolved at 0.1 molar concentration at 20° C. in an inert solvent solution containing a 0.1 molar concentration of a tagged ligand of the same species which is uncoordinated, exhibits essentially no exchange of uncoordinated and coordinated ligands for at least 1 minute. Application of the processing composition using printing techniques, such as by printing with a stamp, is disclosed in U.S. Pat. No. 3,989,526.

Prior art processes have therefore realized patterns of an electroless deposition catalyst by either modifying a uniform coating by local application of an energy source be it with heat, light, X-rays, electrons, ions or some other energy source, by contactless printing techniques, such as ink-jet, electrostatic or electrophotographic techniques, by relatively low resolution contact printing processes such as screen printing or relatively slow contact printing processes such as stamp printing.

There is therefore a need for processes not involving multiple process steps with removal of material, which lend themselves to mass production of high resolution patterns of electroless deposition catalysts. In respect of the catalyst, the avoidance of additives is preferred to prevent poisoning of the catalytic species and the resulting reduction in catalytic activity and to avoid embedding of the catalyst due to the resulting inaccessibility of the catalyst.

### ASPECTS OF THE INVENTION

It is therefore an aspect of the present invention to provide a process for the mass production of patterns of electroless deposition catalysts.

It is therefore a further aspect of the present invention to provide a high resolution process for the mass production of patterns of electroless deposition catalysts.

It is therefore also an aspect of the present invention to provide a process for producing a pattern of electroless deposition catalyst from aqueous media.

It is also an aspect of the present invention to provide a process for realizing a pattern of electroless deposition catalyst, which does not require activation prior to electroless deposition.

Further aspects and advantages of the invention will become apparent from the description hereinafter.

### SUMMARY OF THE INVENTION

Surprisingly it has been found that a high resolution pattern of an electroless deposition catalyst can be realized from aqueous media in a single step, without resorting to photographic techniques, in a low cost high speed process which lends itself to mass production. Moreover, the electroless deposition catalyst thereby deposited does not require activation prior to electroless deposition.

Aspects of the present invention are realized by a process comprising the step of: contact printing a pattern of an electroless deposition catalyst via a hydrophilic phase to a receiving medium, wherein the electroless deposition catalyst requires no activation prior to electroless deposition.

Preferred embodiments are disclosed in the dependent claims.

### DETAILED DESCRIPTION OF THE INVENTION

### Definitions

The term “alkoxy” means all variants possible for each number of carbon atoms in the alkoxy group i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

The term “transparent layer” as used in disclosing the present invention means permitting the passage of light in such a way that objects can be clearly seen through the layer.

The term “aqueous medium” means a medium containing water and water-miscible organic solvents containing between 50% by weight of water and 100% by weight of water.

The term “layer”, as used in disclosing the present invention, means a continuous coating unless qualified by the adjective “non-continuous”.

The term “pattern”, as used in disclosing the present invention, means a non-continuous coating, which may be an array, arrangement or configuration of lines and/or shapes, areas and/or regions.

The term “functional” in the expression “functional patterns” as used in disclosing the present invention means having at least one function that is non-decorative, although functional materials as used in disclosing the present application may have a decorative function or utility in addition to a non-decorative function or utility. Examples of such functions are non-decorative colouring, pH-indicating, whitening, fluorescent, phosphorescent, X-ray phosphor, conductive properties and catalysis. The term functional pattern therefore includes patterns of catalytic species including electroless deposition catalysts.

The term “catalyst” in the expression “electroless deposition catalyst” as used in disclosing the present invention means a substance which alters the rate of a chemical reaction or physical process without itself being consumed i.e. it can accelerate or decelerate a chemical reaction e.g. electroless deposition. The term catalyst does not include species which of themselves have no electroless deposition catalytic properties, although they may be precursors of a species which does perform the function of an electroless deposition catalyst. Autocatalysts are here included in the term catalyst.

The term “electroless deposition”, as used in disclosing the present invention, means deposition of conducting species, such as metals, without using electrochemical techniques. Electroless deposition techniques usually involve a reaction between an oxidizing and a reducing species.

The term “hydrophilic phase”, as used in disclosing the present invention, means a phase with substantially hydrophilic properties i.e. containing or having an affinity for, attracting, adsorbing, or absorbing water. The hydrophilic phase mainly contains water and hydrophilic substances e.g. alcohols and cellulose derivatives, although small quantities of hydrophobic substances may be present.

The term “flexible”, as used in disclosing the present invention, means capable of following the curvature of a curved object such as a drum e.g. without being damaged.

The term “printing ink”, as used in disclosing the present invention, means an ink or one phase of a single fluid ink. The ink can be either hydrophilic i.e. accepted by the hydrophilic areas of a printing plate, roll or stamp, as used, for example, in reverse offset inks, or oleophilic i.e. accepted by the oleophilic areas of a printing plate, roll or stamp, as used, for example, in conventional offset inks. It may or may not contain at least one dye and/or pigment as colorant(s).

The term “dye”, as used in disclosing the present invention, means a coloring agent having a solubility of 10 mg/L or more in the medium in which it is applied and under the ambient conditions pertaining.

The term “pigment”, as used in disclosing the present invention, is defined in DIN 55943, herein incorporated by reference, as an inorganic or organic, chromatic or achromatic coloring agent that is practically insoluble in the application medium under the pertaining ambient conditions, hence having a solubility of less than 10 mg/L therein.

The term “binder”, as used in disclosing the present invention, means a polymeric species, which may be naturally occurring material, a modified naturally occurring material or a synthetic material.

The term “coated paper”, as used in disclosing the present invention, means paper coated with any substance i.e. includes both clay-coated paper and resin-coated paper.

PET as used in the present disclosure represents poly(ethylene terephthalate).

The term “diffusion transfer reversal (DTR) process”, as used in disclosing the present invention, refers to a process developed independently by A. Rott [GB patent 614,155 and Sci. Photogr., (2) 13, 151(1942)] and E. Weyde [DE patent 973,769] and described by G. I. P. Levenson in Chapter 16 of “The Theory of the Photographic Process Fourth Edition”, edited by T. H. James, pages 466 to 480, Eastman Kodak Company, Rochester (1977), herein incorporated by reference.

The term “ionomer”, as used in disclosing the present invention, means a polymer with covalent bonds between the elements of the chain, and ionic bonds between the chains e.g. metal salts of copolymers of ethylene and methacrylic acid commercialized by Du Pont under the tradename SURLYN®.

### Printing Processes

According to the process for contact printing a pattern of an electroless deposition catalyst of the present invention, the pattern of an electroless deposition catalyst is printed via a hydrophilic phase.

According to a first embodiment of the process, according to the present invention, the pattern of electroless deposition catalyst consists of continuous areas of electroless deposition catalyst.

According to a second embodiment of the process, according to the present invention, the contact printing process comprises the steps of: applying a pattern of an electroless deposition catalyst via a hydrophilic phase to an intermediate stamp, plate or roller and transferring the pattern of electroless deposition catalyst from the intermediate stamp, plate or roller to a receiving medium.

According to a third embodiment of the process, according to the present invention, the contact printing process comprises the steps of: applying a pattern of an electroless deposition catalyst via a hydrophilic phase to a printing plate master and transferring the pattern of electroless deposition catalyst from the printing plate master to a receiving medium.

Preferred printing techniques include conventional offset printing with an aqueous fountain and an oleophilic ink, reverse offset printing using a hydrocarbon or mineral oil as fountain medium and a hydrophilic ink, offset printing using single fluid inks consisting of a fine emulsion of the ink in the fountain or of a fine emulsion of the fountain in the ink and driography using water-based driographic inks.

Offset printing has the advantage of printing smooth continuous areas at very high speeds with high resolution. Evaporation of solvent and/or water from the offset fluids is very low in the printing press compared to e.g. screen printing.

### Electroless Deposition Catalyst

According to the process for contact printing a pattern of an electroless deposition catalyst of the present invention, the pattern of an electroless deposition catalyst is printed via a hydrophilic phase.

Development nuclei of the type well known in diffusion transfer reversal (DTR) image receiving materials are preferred electroless deposition catalysts e.g. noble metal particles, such as silver particles, and colloidal heavy metal sulfide particles, such as colloidal palladium sulfide, nickel sulfide and mixed silver-nickel sulfide. These nuclei may be present with or without a binding agent.

According to a fourth embodiment of the process, according to the present invention, the electroless deposition catalyst is non-metallic e.g. palladium, silver, nickel, and cobalt sulphides.

According to a fifth embodiment of the process, according to the present invention, the electroless deposition catalyst is a heavy metal sulphide, e.g. palladium, silver, nickel, cobalt, copper, lead and mercury sulphides, or a mixed sulphide, e.g. silver-nickel sulphide.

According to a sixth embodiment of the process, according to the present invention, the electroless deposition catalyst is metallic e.g. silver, platinum, rhodium, iridium, gold, ruthenium, palladium and copper particles.

According to a seventh embodiment of the process, according to the present invention, the electroless deposition catalyst is capable of catalyzing silver deposition.

### Hydrophilic Phase

According to the process for contact printing a pattern of an electroless deposition catalyst of the present invention, the pattern of an electroless deposition catalyst is printed via a hydrophilic phase.

The hydrophilic phase may also contain: water-soluble gums, a pH buffer system, desensitizing salts, acids or their salts, wetting agents, solvents, non-piling or lubricating additives, emulsion control agents, viscosity builders, biocides and defoamers. However, the presence of additives in the hydrophilic phase should be avoided if at all possible to prevent pollution/poisoning of the electroless deposition catalyst with resulting reduction in catalytic activity.

According to an eighth embodiment of the process, according to the present invention, the hydrophilic phase only contains water and the electroless deposition catalyst.

According to a ninth embodiment of the process, according to the present invention, the hydrophilic phase further contains at least one water-miscible organic compound, such as aliphatic alcohols, ketones, arenes, esters, glycol ethers, cyclic ethers, such as tetrahydrofuran, and their mixtures, preferably an organic solvent.

According to a tenth embodiment of the process, according to the present invention, less than 10% by weight of the dissolved and dispersed solids in the hydrophilic phase is binder.

According to an eleventh embodiment of the process, according to the present invention, less than 5% by weight of the dissolved and dispersed solids in the hydrophilic phase is binder. Minimalization of binder-content enables the catalyst species to exhibit maximum activity and prevents embedding of the electroless deposition catalyst species, making them non-accessible.

According to a twelfth embodiment of the process, according to the present invention, the hydrophilic phase is an aqueous fountain medium, such as used in conventional offset printing.

According to a thirteenth embodiment of the process, according to the present invention, the hydrophilic phase is a hydrophilic ink, such as used in reverse offset printing with an oleophilic fountain e.g. of a hydrocarbon or mineral oil, in which the electroless deposition catalyst may replace part or all of the dyes and/or pigments. Depending on the type of catalyst, it may be preferable to eliminate dyes, pigments or other additives from the ink to prevent pollution of the catalyst, hereby possibly reducing its efficiency. In addition, this would result in a higher concentration of catalyst in the dried layer.

According to a fourteenth embodiment of the process, according to the present invention, the hydrophilic phase is a hydrophilic ink in which the concentration of electroless deposition catalyst is between 10⁻⁸ and 1 mol/L, preferably between 0.001 and 0.1 mol/L.

According to a fifteenth embodiment of the process, according to the present invention, the hydrophilic phase is the dispersing phase of a single fluid ink, such as used in offset printing. The hydrophilic phase in single fluid inks is mainly based on ethylene glycols. To prevent coagulation and maintain a high efficiency of the catalyst, it may be necessary to replace a part of the ethylene glycols with water.

According to a sixteenth embodiment of the process, according to the present invention, the hydrophilic phase is the dispersing phase of a single fluid ink and the electroless deposition catalyst is present in a concentration of between 10⁻⁸ and 1 mol/L, preferably between 0.001 and 0.1 mol/L.

According to a seventeenth embodiment of the process, according to the present invention, the hydrophilic phase is the dispersed phase of a single fluid ink, such as used in offset printing.

According to an eighteenth embodiment of the process, according to the present invention, the hydrophilic phase is a water-based driographic ink, in which the electroless deposition catalyst may replace a part or all of the dyes and/or pigments. Depending on the type of catalyst, it may be preferable to eliminate dyes, pigments or other additives from the ink to prevent pollution of the catalyst, hereby possibly reducing its efficiency. In addition, this would result in a higher concentration of catalyst in the dried layer.

According to a nineteenth embodiment of the process, according to the present invention, the hydrophilic phase is a water-based driographic ink, which contains electroless deposition catalyst in a concentration of between 10⁻⁸ and 1 mol/L, preferably between 0.001 and 0.1 mol/L.

According to a twentieth embodiment of the process, according to the present invention, the hydrophilic phase is exclusive of an ionomer.

According to a twenty-first embodiment of the process, according to the present invention, the hydrophilic phase comprises other functional ingredients e.g. selected from the group consisting of fluorescent, phosphorescent, pH-indicating, coloring, whitening and intrinsically conductive ingredients.

According to a twenty-second embodiment of the process, according to the present invention, the electroless deposition catalyst is incorporated into a hydrophilic phase, which has a viscosity at 25° C. after stirring to constant viscosity of at least 30 mPa·s as measured according to DIN 53211 i.e. until successive measurements according to DIN 53211 are reproducible.

According to a twenty-third embodiment of the process, according to the present invention, the electroless deposition catalyst is incorporated in a hydrophilic phase, which has a viscosity at 25° C. after stirring to constant viscosity of at least 100 mPa·s as measured according to DIN 53211 i.e. until successive measurements according to DIN 53211 are reproducible.

According to a twenty-fourth embodiment of the process, according to the present invention, the electroless deposition catalyst is incorporated into a hydrophilic phase, which has a viscosity at 25° C. after stirring to constant viscosity of at least 200 mPa·s as measured according to DIN 53211 i.e. until successive measurements according to DIN 53211 are reproducible.

According to a twenty-fifth embodiment of the process, according to the present invention, the electroless deposition catalyst is incorporated into a hydrophilic phase, which has a pH between 1.5 and 5.5.

### Aqueous Fountain Medium

According to a twenty-sixth embodiment of the process, according to the present invention, the electroless deposition catalyst is incorporated into an aqueous fountain medium.

According to a twenty-seventh embodiment of the process, according to the present invention, the electroless deposition catalyst is present in the fountain medium in a concentration of 10⁻⁸ to 1 mol/L, preferably between 0.001 and 0.1 mol/L.

The aqueous fountain media may also contain: water-soluble gums, a pH buffer system, desensitizing salts, acids or their salts, wetting agents, solvents, non-piling or lubricating additives, emulsion control agents, viscosity builders, biocides and defoamers.

According to a twenty-eighth embodiment of the process, according to the present invention, the electroless deposition catalyst is incorporated into an aqueous fountain medium, which further comprises an anti-foaming agent. Suitable anti-foaming agents include the silicone antifoam agent X50860A from Shin-Etsu.

According to a twenty-ninth embodiment of the process, according to the present invention, the electroless deposition catalyst is incorporated into an aqueous fountain medium, which further contains a water-soluble gum, such as gum arabic, larch gum, CMC, PVP, and acrylics.

### Water-Miscible Organic Compound

According to a thirtieth embodiment of the process, according to the present invention, the hydrophilic phase further contains at least one water-miscible organic compound, such as aliphatic alcohols, ketones, arenes, esters, glycol ethers, cyclic ethers, such as tetrahydrofuran, and their mixtures.

### Oleophilic Phase

According to the process for contact printing a pattern of an electroless deposition catalyst of the present invention, the pattern of an electroless deposition catalyst is printed via a hydrophilic phase.

According to a third-first embodiment of the process, according to the present invention, an oleophilic phase is involved in the contact printing process.

According to a thirty-second embodiment of the process, according to the present invention, an oleophilic phase is involved in the contact printing process and the oleophilic phase is an oleophilic fountain.

According to a thirty-third embodiment of the process, according to the present invention, an oleophilic phase is involved in the contact printing process and the oleophilic phase is the dispersed phase of a single fluid ink.

According to a thirty-fourth embodiment of the process, according to the present invention, an oleophilic phase is involved in the contact printing process and the oleophilic phase is the continuous phase of a single fluid ink.

According to a thirty-fifth embodiment of the process, according to the present invention, an oleophilic phase is involved in the contact printing process and the oleophilic phase is an oleophilic ink.

### Pigments and Dyes

According to the process for contact printing a pattern of an electroless deposition catalyst of the present invention, the pattern of an electroless deposition catalyst is printed via a hydrophilic phase and an oleophilic phase may be involved in the contact printing process.

According to a thirty-sixth embodiment of the process, according to the present invention, the hydrophilic phase contains at least one colorant, which may be a pigment or dye.

According to a thirty-seventh embodiment of the process, according to the present invention, the colorant in the hydrophilic phase is a dye.

According to a thirty-eighth embodiment of the process, according to the present invention, an oleophilic phase is involved in the contact printing process and the oleophilic phase contains a colorant, which may be a pigment or a dye.

According to a thirty-ninth embodiment of the process, according to the present invention, an oleophilic phase is involved in the contact printing process and the oleophilic phase contains a dye.

The colorant may be selected from the group consisting of pigments and dyes, may either be present in the hydrophilic phase or in an oleophilic phase e.g. the dispersed phase in a single fluid ink, an oleophilic fountain in the case of reverse offset printing or the oleophilic “ink” in the case of conventional offset printing.

Transparent coloured compositions can be realized by incorporating pigments e.g. azo pigments e.g. DALMAR® Azo Yellow and LEVANYL® Yellow HRLF, dioxazine pigments e.g. LEVANYL® Violet BNZ, phthalocyanine blue pigments, phthalocyanine green pigments, Molybdate Orange pigments, Chrome Yellow pigments, Quinacridone pigments, Barium precipitated Permanent Red 2B, manganese precipitated BON Red, Rhodamine B pigments and Rhodamine Y pigments.

Suitable dyes include:

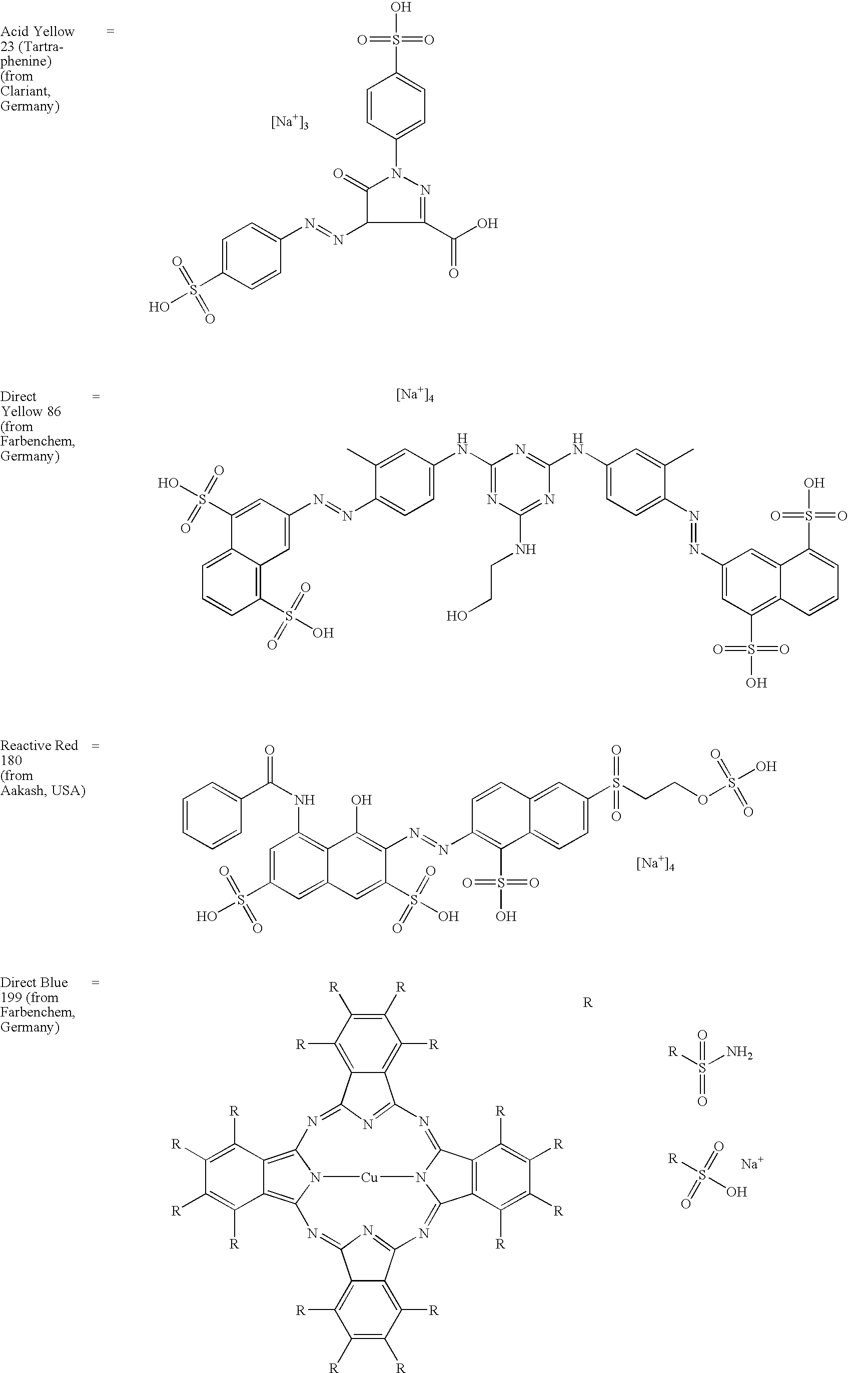

According to a fortieth embodiment of the process, according to the present invention, the hydrophilic and/or oleophilic phase contains a dye and/or a pigment such that the colour tone of the ink and the background cannot be distinguished by the human eye e.g. by colour matching or colour masking by for example matching the CIELAB a*, b* and L* values as defined in ASTM Norm E179-90 in a R(45/0) geometry with evaluation according to ASTM Norm E308-90.

### Surfactants

According to a forty-first embodiment of the process, according to the present invention, the aqueous fountain medium further contains at least one surfactant i.e. at least one surfactant selected from the group consisting of cationic, anionic, amphoteric and non-ionic surfactants.

According to a forty-second embodiment of the process, according to the present invention, the aqueous fountain medium further contains at least one non-ionic surfactant e.g. ethoxylated/fluoro-alkyl surfactants, polyethoxylated silicone surfactants, polysiloxane/polyether surfactants, ammonium salts of perfluoro-alkylcarboxylic acids, polyethoxylated surfactants and fluorine-containing surfactants.

Suitable non-ionic surfactants include:
NON01 SURFYNOL® 440: an acetylene compound with two polyethylene oxide chains having 40 wt % of polyethylene oxide groups from Air Products
NON02 SYNPERONIC®13/6.55 a tridecylpolyethylene-glycol
NON03 ZONYL® FSO-100: a mixture of ethoxylated fluorosurfactants F(CF₂CF₂)₁₋₇CH₂CH₂O(CH₂CH₂O)_{y}H where y=0 to ca. 15 from DuPont;
NON04 ARKOPAL™ N060: a nonylphenylpolyethylene-glycol from HOECHST
NON05 FLUORAD® FC129: a fluoroaliphatic polymeric ester from 3M
NON06 PLURONIC® L35 a polyethylene-glycol/propylene-glycol
NON07 TEGOGLIDE® 410: a polysiloxane-polymer copolymer surfactant, from Goldschmidt;
NON08 TEGOWET®: a polysiloxane-polyester copolymer surfactant, from Goldschmidt;
NON09 FLUORAD® FC126: a mixture of ammonium salts of perfluorocarboxylic acids, from 3M;
NON10 FLUORAD® FC430: a 98.5% active fluoroaliphatic ester from 3M;
NON11 FLUORAD® FC431: CF₃(CF₂)₇SO₂(C₂H₅)N—CH₂CO—(OCH₂CH₂)ₙOH from 3M;
NON12 Polyoxyethylene-10-lauryl ether
NON13 ZONYL® FSN: a 40% by weight solution of F(CF₂CF₂)₁₋₉CH₂CH₂O(CH₂CH₂O)ₓH in a 50% by weight solution of isopropanol in water where x=0 to about 25, from DuPont;
NON14 ZONYL® FSN-100: F(CF₂CF₂)₁₋₉CH₂CH₂O(CH₂CH₂O)ₓH where x=0 to about 25, from DuPont;
NON15 ZONYL® FS300: a 40% by weight aqueous solution of a fluorinated surfactant, from DuPont;
NON16 ZONYL® FSO: a 50% by weight solution of a mixture of ethoxylated fluoro-surfactants with the formula: F(CF₂CF₂)₁₋₇CH₂CH₂O(CH₂CH₂O)_{y}H where y=0 to ca. 15 in a 50% by weight solution of ethylene glycol in water, from DuPont;

According to a forty-third embodiment of the process, according to the present invention, the aqueous fountain medium further contains at least one anionic surfactant. Suitable anionic surfactants include:
AN01 HOSTAPON® T a 95% concentrate of purified sodium salt of N-methyl-N-2-sulfoethyl-oleylamide, from HOECHST 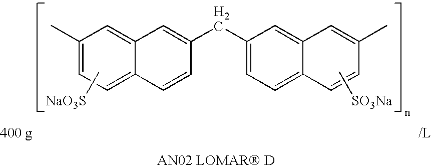
AN03 AEROSOL® OT an aqueous solution of 10 g/L of the sodium salt of the di-2-ethylhexyl ester of sulphosuccinic acid from American Cyanamid
AN04 DOWFAX 2A1 a 45% by weight aqueous solution of a mixture of the sodium salt of bis (p-dodecyl,sulpho-phenyl)-ether and the sodium salt of (p-dodecyl,sulpho-phenyl)-(sulphophenyl)ether from Dow Corning
AN05 SPREMI tetraethylammonium perfluoro-octylsulphonate
AN06 TERGO sodium 1-isobutyl,4-ethyl-n-octylsulphate
AN07 ZONYL® 7950 a fluorinated surfactant, from DuPont;
AN08 ZONYL® FSA a 25% by weight solution of F(CF₂CF₂)₁₋₉CH₂CH₂SCH₂CH₂COOLi in a 50% by weight solution of isopropanol in water, from DuPont;
AN09 ZONYL® FSE: 14% by weight solution of [F(CF₂CF₂)₁₋₇CH₂CH₂O]ₓP(O)(ONH₄)_{y} where x=1 or 2; y=2 or 1; and x+y=3 in a 70% by weight solution of ethylene glycol in water, from DuPont;
AN10 ZONYL® FSJ: 40% by weight solution of a blend of F(CF₂CF₂)₁₋₇CH₂CH₂O]ₓP(O)(ONH₄)_{y} where x=1 or 2; y=2 or 1; and x+y=3 with a hydrocarbon surfactant in 25% by weight solution of isopropanol in water, from DuPont;
AN11 ZONYL® FSP 35% by weight solution of [F(CF₂CF₂)₁₋₇CH₂CH₂O]ₓP(O)(ONH₄)_{y} where x=1 or 2; y=2 or 1 and x+y=3 in 69.2% by weight solution of isopropanol in water, from DuPont;
AN12 ZONYL® UR: [F(CF₂CF₂)₁₋₇CH₂CH₂O]ₓP(O)(OH)_{y} where x=1 or 2; y=2 or 1 and x+y=3, from DuPont;
AN13 ZONYL® TBS: 33% by weight solution of F(CF₂CF₂)₃₋₈CH₂CH₂SO₃H in a 4.5% by weight solution of acetic acid in water, from DuPont;
AN14 ammonium salt of perfluoro-octanoic acid.

According to a forty-fourth embodiment of the process, according to the present invention, the aqueous fountain medium further contains at least one amphoteric surfactant. Suitable amphoteric surfactants include:
AMP01 AMBITERIC® H a 20% by weight solution of hexadecyldimethyl-ammonium acetic acid in ethanol

### Receiving Medium

According to a forty-fifth embodiment of the process, according to the present invention, the receiving medium is any receiving medium suitable for printing, which may be flexible or rigid. Flexible media include but are not limited to paper, carton, cardboard, coated paper, a metallic foil or a plastic sheet or a composite of any of these materials. Rigid media include but are not limited to glass, ceramics, epoxy resins or plastics or a composite of any of these materials.

According to a forty-sixth embodiment of the process, according to the present invention, the receiving medium is paper, coated paper, a metallic foil or a plastic sheet.

The receiving medium may be translucent, transparent or opaque. Suitable plastic sheets include a polymer laminate, a thermoplastic polymer foil or a duroplastic polymer foil e.g. made of a cellulose ester, cellulose triacetate, cellulose butyrate, cellulose nitrate, polypropylene, polycarbonate or polyester, with poly(ethylene terephthalate) or poly(ethylene naphthalene-1,4-dicarboxylate) being particularly preferred. Coated papers include laminates of paper, cardboard or carton with one or more layers of a polymeric material such as polyethylene or polypropylene.

According to a forty-seventh embodiment of the process, according to the present invention, the receiving medium is coated with additional layers, such as a subbing layer or receiver layer to render the substrate additionally adherent and receptive. Any of the many subbing materials which are well known in e.g. the photographic arts can be used. Typical of such subbing materials are gelatin, vinyl polymers such as polyvinyl alcohol and numerous polymeric materials, as well as other chemical compounds and compositions.

### Electroless Deposition Process

The electroless deposition catalyst can serve as nuclei for electroless plating. The use of electroless plating is well known to those skilled in the art and is for example used in PCB manufacturing. Different metals such as nickel, silver, copper, gold, gold alloys, platinum, ruthenium, rhodium, cobalt and cobalt alloys [“Electroless Plating—Fundamentals and Applications”, edited by Glenn O. Mallory and June B. Hajdu, William Andrew Publishing/Noyes (1990)] can be plated electrolessly.

According to a forty-eighth embodiment of the process, according to the present invention, the process further comprises the step of electroless deposition on the pattern of electroless deposition catalyst.

According to a forty-ninth embodiment of the process, according to the present invention, multiple layers of electroless deposition catalyst are printed sequentially to fabricate devices. Each layer can have a different pattern and can be followed by a necessary process step, e.g. developing or plating, before the next printing step is carried out.

### Diffusion Transfer Reversal (DTR) Process

According to a fiftieth embodiment of the process, according to the present invention, the process further comprises the step of electroless deposition on the pattern of electroless deposition catalyst by a diffusion transfer reversal process in which a pattern of development nuclei is physically developed via a silver salt.

For example, the three steps of printing development nuclei, a DTR process to convert the nuclei pattern to a conductive pattern and printing an insulating layer, can be repeated several times to create multilayered printed circuit boards. The printing of development nuclei and subsequent DTR to produce a conductive pattern, can be followed by the printing of enzymes for building in this way a (bio)sensor.

According to a fifty-first embodiment of the process, according to the present invention, the process further comprises the step of electroless deposition on the pattern of electroless deposition catalyst by a diffusion transfer reversal process comprising developing the electroless deposition catalyst with an unexposed silver halide containing layer (transfer emulsion layer) on a substrate, the amount of silver halide in the transfer emulsion layer being preferably between 0.1 and 10 g/m² AgNO₃ and particularly preferably between 1 and 5 g/m² and with a ratio of gelatin to silver halide in the range of 0.05 to 4.0.

According to a fifty-second embodiment of the process, according to the present invention, the process further comprises the steps of electroless deposition on the pattern of electroless deposition catalyst by a diffusion transfer reversal process; and removal of the colored ink pattern which does not contain electroless deposition catalyst from the substrate, e.g. when the transfer emulsion layer is separated from the substrate after the DTR process. This will occur when the oleophilic colored ink in a conventional offset printing process has a low affinity towards the substrate, compared to the affinity towards the transfer emulsion layer. This is for example the case if the substrate is hydrophilic or has a hydrophilic coating layer, such as a gelatin layer. The advantage of the removal of the ink pattern, is that a second pattern of electroless deposition catalyst can be printed via the fountain medium, without the risk of poor transfer of the fountain medium from the offset blanket to the oleophilic ink-covered substrate regions. In case a first pattern of electroless deposition catalyst is (partially) overcoated with an oleophilic colored ink in a second print step, the electroless deposition catalyst will be less or no longer available to interact with chemicals with which the printed substrate is brought in contact. Removal of the oleophilic colored ink of the second print step via DTR would uncover the underlying layer of electroless deposition catalyst again, regaining its functionality.

### INDUSTRIAL APPLICATION

The process according to the present invention can, for example, be used to produce conductive patterns for a multiplicity of applications including electroplating with metallic layers, sensors, the production of electrical circuitry for single and limited use items such as toys, in capacitive antennae as part of radiofrequency tags, in electroluminescent devices which can be used in lamps, displays, back-lights e.g. LCD, automobile dashboard and keyswitch backlighting, emergency lighting, cellular phones, personal digital assistants, home electronics, indicator lamps and other applications in which light emission is required.

The invention is illustrated hereinafter by way of COMPARATIVE EXAMPLES and INVENTION EXAMPLES. The percentages and ratios given in these examples are by weight unless otherwise indicated.

Receiving media:

| Receiving | |
|---|---|
| medium nr. | |
| 1 | 125 μm PET with an adhesion promoting layer No. 01 |
| 2 | 125 μm PET with an adhesion promoting layer No. 01, |
| | subbing layer No. 02 and 15 m²/l gelatin layer No. 03 |
| 3 | 125 μm PET with an adhesion promoting layer No. 01, |
| | subbing layer No. 02 and 25 m²/l gelatin layer No. 03 |
| 4 | 125 μm PET with an adhesion promoting layer No. 01, |
| | subbing layer No. 02 and 50 m²/l gelatin layer No. 03 |
| 5 | PE-coated paper No. 04 with 25 m²/l gelatin layer No. 03 |

The coating solution for the adhesion promoting layer No. 01 has the following composition and was coated at 130 m²:

| | |
|---|---|
| Copolymer of 88% vinylidene chloride, 10% methyl | 68.8 g |
| acrylate and 2% itaconic acid | |
| Kieselsol ™ 100F, a colloidal silica from BAYER | 16.7 g |
| Mersolat ™ H, a surfactant from BAYER | 0.36 g |
| Ultravon ™ W, a surfactant from CIBA-GEIGY | 1.68 g |
| Water to make | 1000 g |

The coating solution for the subbing layer No. 02 has the following composition and was coated at 30 m²:

| | |
|---|---|
| Gelatin | 11.4 g |
| Kieselsol ™ 100F-30, a colloidal silica from BAYER | 10.08 g |
| Ultravon ™ W, a surfactant from CIBA-GEIGY | 0.4 g |
| Arkopal | 0.2 g |
| Hexylene glycol | 0.67 g |
| Trimethylolpropane | 0.33 g |
| Copolymer of 74% maleic acid, 25% styrene and 1% | 0.03 g |
| methylmethacrylate | |
| Water to make | 1000 g |

The coating solution for the gelatin layer No. 03 has the following composition:

| | |
|---|---|
| Gelatin | 40 g |
| Hostapon ™ T, a surfactant from CLARIANT | 1 g |
| Formaldehyde (4%) | 40 g |
| Water to make | 1000 g |

PE-coated paper No. 04 is a photographic paper from F. Schoeller, consisting of paper (166 g/m²) with a TiO₂-containing PE layer (28 g/m²), overcoated with a gelatin layer (0.25 g/m²). The backside is a layer of 47% LDPE and 53% HDPE (24 g/m²).

### EXAMPLE 1

### Offset Printing of Development Nuclei via the Fountain as Hydrophilic Phase

The preparation of palladium sulphide physical development nuclei is described in the example of EP-A 0 769 723, herein incorporated by reference. From this example, solutions A1, B1 and C1 were used to prepare a nuclei dispersion with a concentration of 0.0038 mol/l. 10 grams of isopropanol was added to 90 grams of this dispersion. This was “fountain medium A”.

10 grams of isopropanol was added to 90 grams of a dispersion of silver physical development nuclei with a concentration of 0.027 mol/l Ag and an average particle size of 5-6 nm. This was “fountain medium B”.

Printing experiments were carried out with a 360 offset printer from A.B. Dick with MT253 Yellow, a yellow offset ink from Sun Chemical, using a Thermostar™ P970/15 printing plate, receiving media 1 to 3 as described above and “fountain medium A” and “fountain medium B”. With both fountain media 150 prints were made without deterioration of the print quality, the non-printed areas containing the fountain dispersion were colourless.

The preparation of the silver chlorobromide emulsion and the preparation of the transfer emulsion layer were as disclosed in EP-A 769 723 except that the coverage of silver halide applied was equivalent to 2.35 g/m² of AgNO₃ instead of 2 g/m² thereof. The transfer emulsion layer was processed in contact with the receiving media listed above at 25° C. for 1 minute with an AGFA-GEVAERT™ CP297 developer solution and subsequently dried at room temperature.

After carrying out this diffusion transfer reversal (DTR) process, a silver gray pattern had been formed in the non-inked areas for both “fountain medium A” and “fountain medium B” and for receiving media 2 and 3, showing that development nuclei had been transferred to the receiving media during printing. No coloration was observed for receiving medium 1 after carrying out this diffusion transfer reversal (DTR) process.

The silver areas on receiving medium 2 with “fountain medium A” showed a resistance of 1500 Ω/square. The silver areas on the other samples showed no conductivity. During separation of the transfer emulsion layer and the (hydrophilic) receiving media 2 and 3, the (hydrophobic) yellow ink was transferred to the transfer emulsion layer, while the yellow ink remained on receiving medium 1 after separation.

An additional copper layer was grown on top of the silver pattern by immersing it for 4 minutes in a reducer bath (Reducer Neoganth 406 from Atotech), followed by electroless plating in a copper bath (Printoganth PV from Atotech) for 30 minutes. Copper was only deposited on the silver pattern, resulting in a change from a gray to a copper-colored pattern.

### EXAMPLE 2

### Increasing Conductivity via a Diffusion Transfer Reversal Process

Development nuclei were printed via the “fountain medium A” on receiving medium 2 and then developed via the diffusion transfer reversal process described in example 1. The resistance was 1500 Ω/square. The receiving medium was then developed for a second time via the diffusion transfer reversal process, using the same conditions as described before, resulting in a resistance of 100 Ω/square. Since the transfer emulsion layer did not have to be photoexposed, problems of misalignment of the transfer emulsion layer to the already patterned receiving medium did not occur.

A single DTR process step in which the contact time was increased from 1 to 3 minutes, did not give a reduction in surface resistance compared with the two subsequent DTR processes.

### EXAMPLE 3

### Increasing Conductivity via the Fountain as Hydrophilic Phase

Solutions A1, B1 and C1 were prepared as given below:

| | | | 1% solution of polyvinyl | |
|---|---|---|---|---|
| | (NH₄)₂PdCl₄ | Na₂S | alcohol in | deionized |
| | [g] | [g] | deionized water [mL] | water [mL] |
| A1 | 2.17 | | 25 | 475 |
| B1 | | 2 | 25 | 475 |
| C1 | | 3.2 | 40 | 760 |

The physical development nuclei were prepared, as described in the EXAMPLE in EP-A 0 769 723, by a double jet precipitation in which solution A1 of (NH₄)₂PdCl₄ and solution B1 of sodium sulphide were added at a constant rate during 4 minutes to solution C1 containing sodium sulphide while stirring at 400 rpm. Subsequent to precipitation, the precipitated nuclei obtained were dialysed to a conductivity of 0.5 mS. A 250 g sample of this dispersion was concentrated by evaporation to 50 g and 5 g isopropanol was added. This was “fountain medium C”.

Printing was performed as described in Example 1 on receiving medium 5, with both “fountain medium A” and “fountain medium C”.

After DTR development was performed as described in Example 1, a silver grey pattern was formed in the non-inked areas with receiving medium 5 printed with both “fountain medium A” and “fountain medium C”. With “fountain medium A”, the silver areas showed no conductivity, whereas the surface resistance realized with “fountain medium C” was 170 Ω/square. Hence an increase in the development nuclei concentration in the fountain medium improved the amount of deposited silver and thus the conductivity. The conductivity could be increased even further by a second DTR process, resulting in a resistance of 30 Ω/square.

### EXAMPLE 4

### Increasing Conductivity via Additional Coating Step

Development nuclei were printed via the “fountain medium A” on receiving media 1, 2, 4 and 5 as described in example 1. The prints were then overcoated with “fountain medium A” with a nominal wet coating thickness of 10 μm. The fountain medium dewetted the yellow inked hydrophobic areas and preferentially covered the ‘fountain areas’. After drying at room temperature, the prints were developed via DTR and dried, resulting in conductive patterns with the resistances shown in the table below.

| Receiving | | Gelatin layer | Resistance |
|---|---|---|---|
| medium nr. | Support | thickness | (Ω/square) |
| 1 | PET + adhesion layer | — | >30 × 10⁶ |
| 2 | PET + adhesion layer + gelatine | 1.2 | 20 |
| | layer (15 m²/L) | | |
| 4 | PET + adhesion layer + gelatine | 4.2 | 5 |
| | layer (50 m²/L) | | |
| 5 | PE-coated paper + gelatine | 2.1 | 6 |
| | layer (25 m²/L) | | |

When DTR development was performed on thereby printed receiving media 2 to 5, which all had a gelatin outermost layer, silver layers with surface resistances of 5 to 20 Ω/square were obtained, whereas in absence of a gelatin outermost layer, as in receiving medium 1, no silver was deposited on the nuclei pattern.

It was further found that the surface resistance of the layer obtained by DTR-processing of the development nuclei on receiving medium 2 could be reduced by a factor of 7.6 upon sintering together the silver particles formed in the DTR process by heating with an energy of 1250 mJ/cm² using a IR diode laser (wavelength 830 nm) beam.

The present invention may include any feature or combination of features disclosed herein either implicitly or explicitly or any generalisation thereof irrespective of whether it relates to the presently claimed invention. In view of the foregoing description it will be evident to a person skilled in the art that various modifications may be made within the scope of the invention.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A process comprising the step of: contact printing a pattern of an electroless deposition catalyst via a hydrophilic phase to a receiving medium, wherein said electroless deposition catalyst requires no activation prior to electroless deposition.

2. Process according to claim 1, wherein said contact printing process comprises the steps of: applying a pattern of an electroless deposition catalyst via a hydrophilic phase to a intermediate stamp, plate or roller and transferring said pattern of electroless deposition catalyst from said intermediate stamp, plate or roller to a receiving medium.

3. Process according to claim 2, wherein said intermediate plate is a printing plate master.

4. Process according to claim 1, wherein said electroless deposition catalyst is non-metallic.

5. Process according to claim 1, wherein said electroless deposition catalyst is a heavy metal sulphide.

6. Process according to claim 1, wherein said electroless deposition catalyst is metallic.

7. Process according to claim 1, wherein said electroless deposition catalyst is capable of catalyzing silver deposition.

8. Process according to claim 1, wherein said process for printing is an offset printing process.

9. Process according to claim 1, wherein said hydrophilic phase contains a colorant.

10. Process according to claim 1, wherein said hydrophilic phase is the continuous phase of a single fluid ink.

11. Process according to claim 1, wherein said hydrophilic phase is a hydrophilic ink.

12. Process according to claim 1, wherein said hydrophilic phase is a water-based driographic ink.

13. Process according to claim 1, wherein said hydrophilic phase is an aqueous fountain.

14. Process according to claim 13, wherein said hydrophilic phase has a viscosity at 25° C. after stirring to constant viscosity of at least 30 mPa·s as measured according to DIN 53211.

15. Process according to claim 1, wherein an oleophilic phase is involved in said contact printing process.

16. Process according to claim 15, wherein said oleophilic phase is an oleophilic fountain.

17. Process according to claim 15, wherein said oleophilic phase is the dispersed phase of a single fluid ink.

18. Process according to claim 15, wherein said oleophilic phase is an oleophilic ink.

19. Process according to claim 15, wherein said oleophilic phase contains a colorant.

20. Process according to claim 1, further comprising the step of electroless deposition on said pattern of electroless deposition catalyst.

21. Process according to claim 20, wherein said electroless deposition is by a diffusion transfer reversal process.

22. Process according to claim 20, wherein silver is deposited on said pattern upon contact with a layer containing silver halide particles and a developer.
